(19) United States
(12) Patent Application Publication
(10) Pub. No.: US 2018/0212289 A1
(43) Pub. Date: Jul. 26, 2018

(54) GRAPHENE ENHANCED COOLING FIN

(71) Applicant: James O. Pinon, Troy, MI (US)

(72) Inventor: James O. Pinon, Troy, MI (US)

(21) Appl. No.: 15/856,127

(22) Filed: Dec. 28, 2017

Related U.S. Application Data
(63) Continuation-in-part of application No. 14/853,936, filed on Sep. 14, 2015.
(60) Provisional application No. 62/439,643, filed on Dec. 28, 2016.

(51) Int. Cl. H01M 10/653; H01M 10/613; H01M 10/647; H01M 10/6551; H01M 10/6555; H01M 2/02

(52) U.S. Cl. CPC H01M 10/653; H01M 10/613; H01M 10/647; H01M 10/625; H01M 10/6555; H01M 2/02; H01M 10/6551

(57) ABSTRACT

An apparatus for cooling a multi-battery cell energy storage device includes a graphene enhanced cooling fin. The graphene enhanced cooling fin includes a flat panel portion configured to abut one of the battery cells, the flat panel portion including a graphene enhanced portion configured to transmit heat away from the one of the battery cells and a plastic structural rim portion surrounding the flat panel portion.

### CROSS REFERENCE TO RELATED APPLICATIONS

This disclosure is a continuation in part application of U.S. patent application Ser. No. 14/853,936 filed on Sep. 14, 2015 and claims the benefit of U.S. Provisional Application No. 62/439,643 filed on Dec. 28, 2016, both of which are hereby incorporated by reference.

### TECHNICAL FIELD

This disclosure is related to thermal management systems used in energy storage devices. In particular, the disclosure is related to heat management in multi-cell devices, for example, used in electrically powered or hybrid power vehicles or stationary or back-up power systems.

### BACKGROUND

The statements in this section merely provide background information related to the present disclosure. Accordingly, such statements are not intended to constitute an admission of prior art.

Batteries used in vehicular-scale energy storage generate significant heat, for example, during charging cycles and during power generation/discharge cycles. Placing fins, for example, made of steel or aluminum between battery cells is known whereby the fins act as heat sinks, drawing heat away from the battery cells and transmitting the heat away from the batteries. However, package space within battery packs is limited, and the fins generally must be thin to fit the required package size. As a result, simple fins are limited in how much heat they can manage in a battery pack including multiple battery cells.

Other cooling fin configurations are known. One configuration includes a hollow fin passing a liquid through the fin and exchanging heat from the proximate battery cells into the liquid which is then cycled out of the fin and cooled through known thermal cycles. However, such systems are inherently complex, requiring waterproof seals at every connection point; expensive, requiring a liquid pump and a connecting heat exchanger to dissipate the heat; and prone to exposing the battery cells to liquid from leaking fins and connections.

### SUMMARY

An apparatus for cooling a multi-battery cell energy storage device includes a graphene enhanced cooling fin. The graphene enhanced cooling fin includes a flat panel portion configured to abut one of the battery cells, the flat panel portion including a graphene enhanced portion configured to transmit heat away from the one of the battery cells and a plastic structural rim portion surrounding the flat panel portion.

### BRIEF DESCRIPTION OF THE DRAWINGS

One or more embodiments will now be described, by way of example, with reference to the accompanying drawings, in which:

FIG. 1 illustrates an exemplary graphene enhanced cooling fin for use in a multi-cell battery pack from a top, front perspective view, in accordance with the present disclosure;

FIG. 2 illustrates the graphene enhanced cooling fin of FIG. 1 from a bottom, rear perspective view, in accordance with the present disclosure;

FIG. 3 illustrates an exemplary battery cell aligned for assembly with the enhanced cooling fin of FIG. 1, in accordance with the present disclosure;

FIG. 4 illustrates an exemplary cross sectional view of the enhanced cooling fin of FIG. 1, in accordance with the present disclosure;

FIG. 5 illustrates an exemplary cross sectional view of an alternative embodiment of a graphene enhanced cooling fin with a layer of graphene platelets covering one side of a flat panel portion, in accordance with the present disclosure;

FIG. 6 illustrates an exemplary cross sectional view of an alternative embodiment of a graphene enhanced cooling fin with a layer of graphene platelets covering both sides of a flat panel portion, in accordance with the present disclosure;

FIG. 7 illustrates an exemplary cross sectional view of an alternative embodiment of a graphene enhanced cooling fin with an exemplary enhanced aluminum plate surrounded around a perimeter by an enhanced plastic structural rim portion, in accordance with the present disclosure;

FIG. 8 illustrates an exemplary cross sectional view of an alternative embodiment of a graphene enhanced cooling fin with an exemplary aluminum plate surrounded entirely by an enhanced plastic structural rim portion, in accordance with the present disclosure;

FIG. 9 illustrates an exemplary cross sectional view of an alternative embodiment of a graphene enhanced cooling fin with an exemplary central plate sandwiched on either side entirely by enhanced plastic surface portions, in accordance with the present disclosure;

FIG. 10 illustrates the graphene enhanced cooling fin of FIG. 1 with a battery cell engaged thereto, with the enhanced cooling fin installed to an exemplary liquid cooled cooling plate, in accordance with the present disclosure;

FIG. 11 illustrates the graphene enhanced cooling fin of FIG. 10 separated from the cooling plate for illustration, with two battery cells positioned to be engaged to either side of the enhanced cooling fin, in accordance with the present disclosure;

FIG. 12 illustrates a plurality of enhanced cooling fins attached to the cooling plate of FIG. 10, in accordance with the present disclosure;

FIGS. 13-16 illustrate an additional embodiment of battery cell components that are made with plastic enhanced with graphene, in accordance with the present disclosure;

FIG. 13 illustrates a plastic housing enhanced with graphene configured to transfer heat away from a battery core;

FIG. 14 illustrates coolant lines that can be installed to the enhanced cooling fin of FIG. 13 in order to transfer heat away from the enhanced cooling fin;

FIG. 15 illustrates the enhanced cooling fin and coolant lines of FIG. 14, with a battery core and a cover in an expanded view, with the core in position to be placed within an indented pocket in the enhanced cooling fin; and

FIG. 16 illustrates a plurality of enhanced cooling fins with battery cores installed thereto stacked and attached to coolant lines;

FIG. 17 illustrates an exemplary central processing unit cooling fin constructed with a graphene enhanced plastic material, in accordance with the present disclosure;

FIG. 18 illustrates an additional exemplary central processing unit cooling fin constructed with a graphene enhanced plastic material and including a phase change circuit, in accordance with the present disclosure;

FIG. 19 illustrates an exemplary radiator device used in automotive applications with graphene enhanced plastic cooling structures, in accordance with the present disclosure;

FIG. 20 illustrates an exemplary pair of aluminum plates with a layer of graphene materials interposed between the plates, in accordance with the present disclosure;

FIG. 21 illustrates the aluminum plates and graphene materials of FIG. 20 encased within a molded plastic unit, in accordance with the present disclosure; and

FIG. 22 illustrates the aluminum plates and graphene materials of FIG. 20 partially encased within a molded plastic unit, with heat rejection fins exposed on either side of the aluminum plates, in accordance with the present disclosure.

### DETAILED DESCRIPTION

A device or apparatus including a cooling fin for use in multiple cell battery packs is disclosed, replacing traditional cooling fins and related designs used to remove heat from or transfer heat to battery cells, fuel cells, multiple cell capacitors, or similar energy storage devices.

Throughout the disclosure, heat is generally discussed as being taken away from a battery cell or cells. It will be appreciated that the same structure of cooling fins can be used to heat battery cells or other energy storage cells. In such an embodiment, a coolant heating device can be used, for example, to generate heat through electrical resistance or burning of fuel, and heat can be supplied or maintained to an exemplary battery under cold environmental conditions to achieve a desired operating temperature for the energy storage device.

Graphene is a substance that greatly increases thermal conductivity of a cooling fin substrate. Use of a graphene enhanced cooling fin is disclosed. Enhancing a cooling fin with graphene can be performed according to a number of envisioned embodiments. For example, a single layer of graphene can be applied or deposited upon one or both sides of a substrate. such a substrate can be made of metal, plastic, ceramic material, or any other material known in the art. In another example, layers of graphene can be used upon and between layers of substrate materials. For example, a cooling fin can include layers of aluminum, copper, and/or steel, with layers of graphene deposited between the multiple layers of metal. Two layers of un-enhanced plastic and surround a single layer of graphene enhanced plastic, or two layers of graphene enhanced plastic can surround a single layer of un-enhanced plastic. Layers can be joined or bonded together according to processes known in the art.

In another embodiment, graphene can be mixed with a metal and interspersed within the metal to enhance the metal's properties. Such a composite material can be held together with a binder material. Similarly, graphene can be mixed with plastic material and interspersed within the plastic to enhance the plastic's properties. In another example, a layer or layers of electrical or flame-retardant insulation can be used with the metallic substrate. In another example, expansion-absorbing layers known as gap pads can placed internally or externally to the cooling fin.

While layers of graphene of thicknesses of up to or over 0.5 mm are known and contemplated for use with the presently disclosed cooling fins, layers of as little as one molecule thick can be used upon a cooling fin substrate in accordance with the presently disclosed device. Complete layers or complete sheets of graphene material can be used. However, such sheets can be expensive and difficult to produce and maintain in an undamaged state. Use of graphene platelets is known, where overlapping or contacting segments of graphene flakes or platelets conduct heat similarly to intact sheets of graphene. Throughout the disclosure, graphene enhanced materials can include graphene layers, graphene sheets, or use of graphene platelets.

Known battery cooling fin configurations with sufficient heat transfer capacity to cool battery cells typically include fins utilizing a flow of liquid coolant between the battery cells. Conventional, un-enhanced cooling fins made with a solid panel substrate typically cannot efficiently conduct enough heat away from the battery cells to be effective. Solid-metal or solid-plastic fin substrates enhanced with graphene can used to transfer heat away from the source of the heat, such as a battery cell. Cooling tubes or cold plates in thermally conductive contact with the enhanced cooling fin can subsequently remove heat from the cooling fin. The disclosed graphene enhancements greatly increase a capacity of a solid panel substrate to conduct heat.

Further, graphene enhanced cooling fins are useful for applications where a large amount of heat must be removed or transferred to or from a device. However, the structures disclosed herein and illustrated in the figures can be used with simple metallic fins, such as aluminum or molded plastic fins, depending upon the heat transfer requirements of the application. The disclosure is intended to encompass any structure with the disclosed properties.

A fin or cooling plate can be constructed with a plastic material created through an injection molding process with graphene evenly interspersed through the material. In the process of injection molding or otherwise forming the plastic, graphene can be added to the component plastic pellets used to form the housing, such that graphene is interspersed throughout the plastic material. Testing has shown increased thermal conductivity through a plastic housing infused with graphene as opposed to the same plastic material without the graphene.

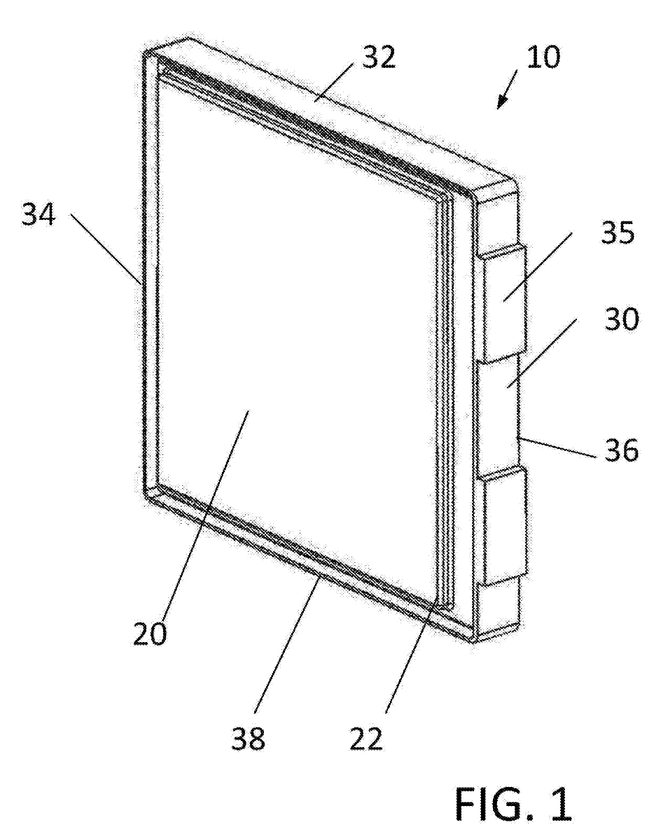

Referring now to the drawings, wherein the showings are for the purpose of illustrating certain exemplary embodiments only and not for the purpose of limiting the same, FIG. 1 illustrates an exemplary graphene enhanced cooling fin for use in a multi-cell battery pack from a top, front perspective view. Graphene enhanced cooling fin 10 is constructed with exemplary graphene enhanced plastic and is illustrated including a flat panel portion 20 and a structural rim portion 30 surrounding flat panel portion 20. Flat panel portion 20 is illustrated with a large surface area configured to be situated in direct contact with a generally rectangle-shaped battery cell on one side of the panel portion or one on each side of the panel portion. Graphene can be coated on one or both sides of the flat panel portion 20.

Flat panel portion 20 can be entirely flat, with a planar panel contacting the structural rim portion 30. In the embodiment of FIG. 1 indentation 22 around a perimeter of flat panel portion 20 provides an indented pocket within which a battery cell configured to fit within the intended pocket can be securely located and help immobile.

Structural rim portion 30 surrounds both flat panel portion 20 and battery cells held next to flat panel portion 20. In this way, structural rim portion 30 protects the delicate battery cells from damage. Further, structural rim portion 30 can be used to provide features through which a plurality of enhanced cooling fins 10 can be stacked and held securely together. For example, structural rim portion 30 of FIG. 1 includes a plurality of protrusions 35 extending outwardly from the surface of structural rim portion 30. These protrusions 35 can be gripped by or be used to guide the location of brackets, straps, or other affixing devices useful to retain the plurality of enhanced cooling fins 10 and the battery cells contained therein in place. The non-limiting, exemplary structural rim portion 30 of FIG. 1 includes a generally rectangular perimeter including top surface 32, side surfaces 34 and 36, and bottom surface 38. Walls of structural rim portion 30 are aligned approximately perpendicular to the flat surface of flat panel portion 20.

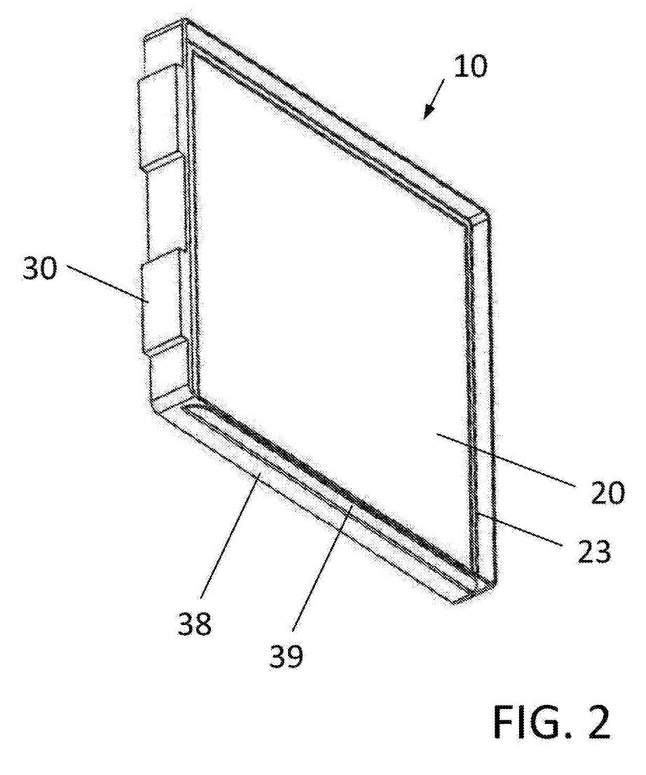

FIG. 2 illustrates the graphene enhanced cooling fin of FIG. 1 from a bottom, rear perspective view. Graphene enhanced cooling fin 10 is illustrated including flat panel portion 20 and structural rim portion 30. Flat panel portion 20 is substantially of uniform thickness across the flat planar surface. Indentation 23 is shown as an inverse of indentation 22 of FIG. 1. Bottom surface 38 is illustrated with an optional lip 39 configured to aid in securing graphene enhanced cooling fin 10 to a plate later to be assembled below the cooling fin.

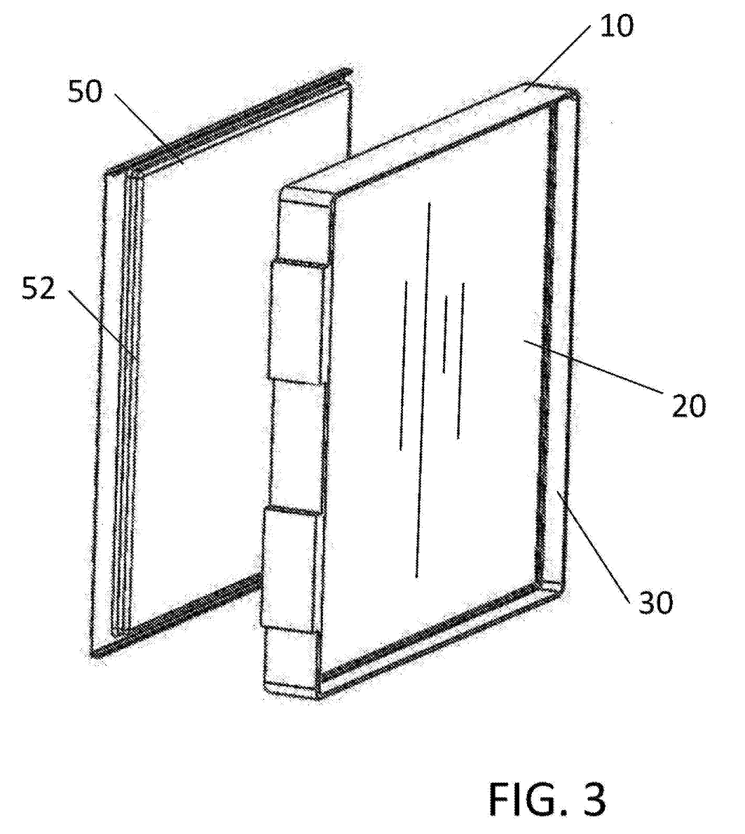

FIG. 3 illustrates an exemplary battery cell aligned for assembly with the enhanced cooling fin of FIG. 1. Graphene enhanced cooling fin 10 is illustrated including flat panel portion 20 and structural rim portion 30. Battery cell 50 is illustrated including contour 52 configured to enable battery cell 50 to align fittingly to the contours of the indented pocket of flat panel portion 20. It will be appreciated that battery cell 50 can include electrical connections of various shapes and sizes configured to connect the cell to other battery cells and to the electrical subsystems of the vehicle or system being powered. Enhanced cooling fin 10 can include cut-outs, indentations, and or electrical fittings not illustrated to facilitate the necessary electrical connections of battery cell 50.

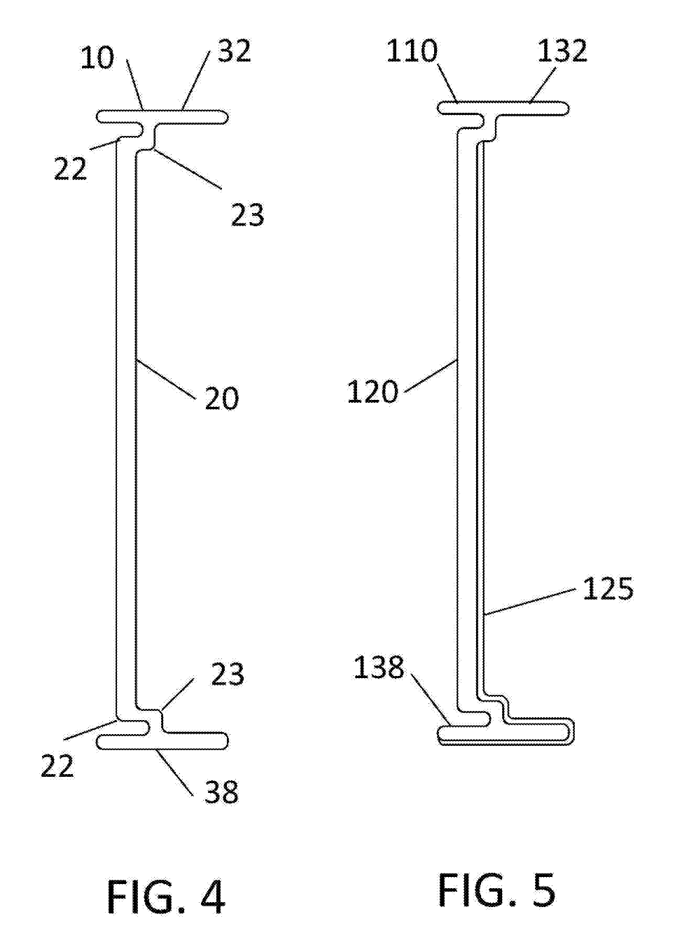

FIG. 4 illustrates an exemplary cross sectional view of the enhanced cooling fin of FIG. 1. Graphene enhanced cooling fin 10 is illustrated including flat panel portion 20, top surface 32 of the structural rim portion, and bottom surface 38 of the structural rim portion. Indentations 22 and 23 are illustrated where the flat panel portion 20 intersects both top surface 32 and bottom surface 38, resulting in the indented pocket shape of flat panel portion 20. Graphene enhanced cooling fin 10 is illustrated without any visually perceptible graphene layer on any surface of the fin and can be exemplary of a cooling fin enhanced with either an imperceptibly thin layer of graphene platelets on one or all surfaces of the fin or with graphene platelets interspersed within plastic material constructing enhanced cooling fin 10.

FIG. 5 illustrates an exemplary cross sectional view of an alternative embodiment of a graphene enhanced cooling fin with a layer of graphene platelets covering one side of a flat panel portion. Graphene enhanced cooling fin 110 is illustrated including flat panel portion 120, top surface 132 of the structural rim portion, and bottom surface 138 of the structural rim portion. A thin but perceptible layer 125 of graphene is illustrated on one side of flat panel portion 120 and projecting contiguously to a bottom side of bottom surface 138. Layer 125 can be any thickness. The illustration of layer 125 is provided in exaggerated as compared to an exemplary layer thickness of 0.5 mm for purposes of illustration. In another embodiment, layer 125 could be illustrated on the other side of flat panel portion 120 or on both sides of flat panel portion 120. Layer 125 running contiguously from flat panel portion 120 to the bottom side of bottom surface 138 provides a low-resistance path for heat to travel along layer 125, transmitting heat from a battery cell neighboring flat panel portion 120 to a cooling plate or other similar structure neighboring the bottom side of bottom surface 138.

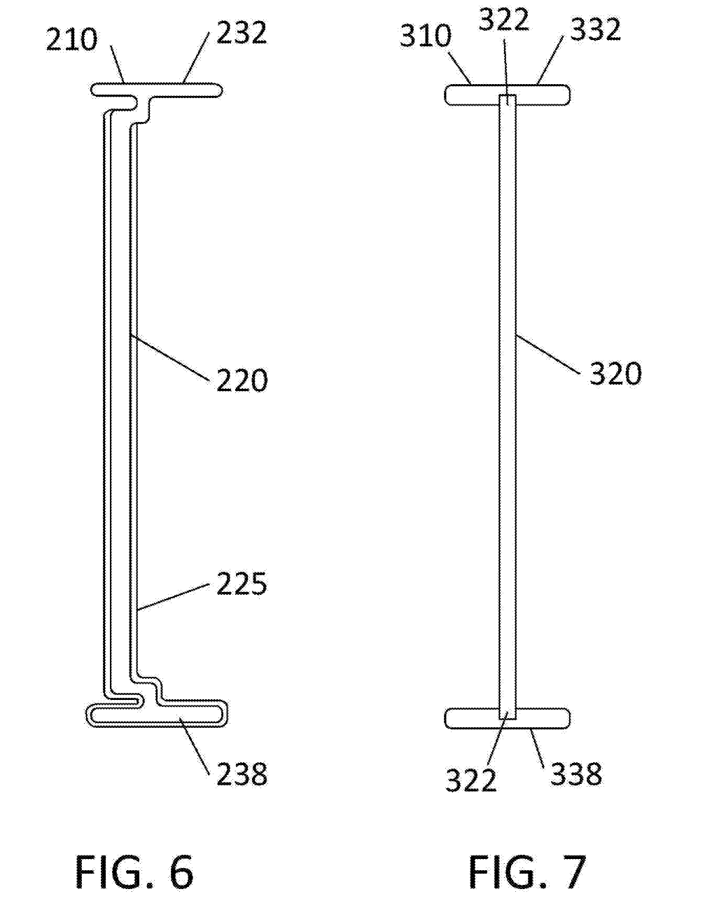

FIG. 6 illustrates an exemplary cross sectional view of an alternative embodiment of a graphene enhanced cooling fin with a layer of graphene platelets covering both sides of a flat panel portion. Graphene enhanced cooling fin 210 is illustrated including flat panel portion 220, top surface 232 of the structural rim portion, and bottom surface 238 of the structural rim portion. Enhanced cooling fin 210 is similar to enhanced cooling fin 110 except that a thin but perceptible layer 225 of graphene is illustrated on both sides of flat panel portion 225 and projecting contiguously to a bottom side of bottom surface 238. Enhanced cooling fin 210 can efficiently transfer heat away from two battery cells, one on either side of flat panel portion 220.

FIG. 7 illustrates an exemplary cross sectional view of an alternative embodiment of a graphene enhanced cooling fin with an exemplary enhanced aluminum plate surrounded around a perimeter by an enhanced plastic structural rim portion. Graphene enhanced cooling fin 310 is illustrated including planar flat panel portion 320, top surface 332 of the structural rim portion, and bottom surface 338 of the structural rim portion. Some embodiments of cooling fins include indented pockets formed upon flat panel portions of the fins. The exemplary embodiment of FIG. 7 includes a planar flat panel portion 320 not including an indented pocket. Planar flat panel portion 320 includes an exemplary graphene enhanced aluminum plate configured to transfer heat away from a neighboring battery cell or cells. A perimeter 322 of flat panel portion 320 is captured or molded within an enhanced plastic structural rim portion including top surface 332 and bottom surface 338. Perimeter 322 can optionally include grooves or other features configured to enhance the physical connection between flat panel portion 320 and the structural rim portion.

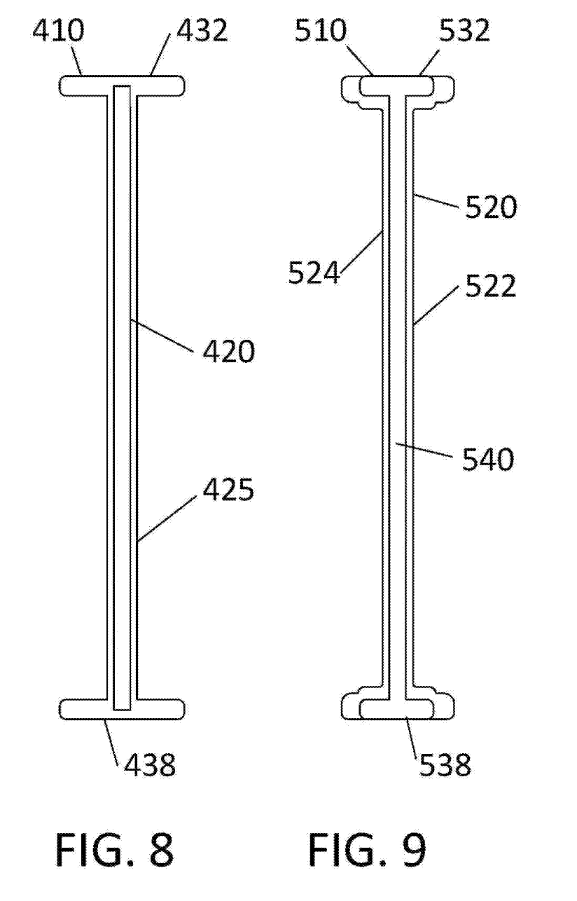

FIG. 8 illustrates an exemplary cross sectional view of an alternative embodiment of a graphene enhanced cooling fin with an exemplary aluminum plate surrounded entirely by an enhanced plastic structural rim portion. Graphene enhanced cooling fin 410 is illustrated including planar flat panel portion 420, top surface 432 of the structural rim portion, and bottom surface 438 of the structural rim portion. Planar flat panel portion 420 can optionally be enhanced with graphene. A layer of graphene enhanced plastic 425 covers both sides of flat panel portion 420. The graphene enhanced material of layers 425 can be contiguously formed with graphene enhanced plastic forming top surface 432 and bottom surface 438 of a structural rim portion. In one embodiment, for manufacturing reasons, small holes can be formed in layers 425 to enable the flat panel portion 420 to be held in place while the plastic material is injection molded around flat panel portion 420.

FIG. 9 illustrates an exemplary cross sectional view of an alternative embodiment of a graphene enhanced cooling fin with an exemplary central plate sandwiched on either side entirely by enhanced plastic surface portions. Graphene enhanced cooling fin 510 is illustrated including planar flat panel portion 520, top surface 532 of the structural rim portion, and bottom surface 538 of the structural rim portion. Cooling fin 510 includes a central plate 540 sandwiched between a first enhanced plastic surface portion 522 and a second enhanced plastic surface portion 524. Battery cells positioned between cooling fins, depending upon the particular configuration of the battery cells, can require that a non-electrically conductive insulator be positioned between the battery cells. Central plate 540 can include a non-conductive material, such as a plastic or other polymer or a ceramic material not enhanced with graphene. First enhanced plastic surface portion 522 and second enhanced plastic surface portion 524 can each transmit heat away from neighboring battery cells, but because first enhanced plastic surface portion 522 and second enhanced plastic surface portion 524 are separated by the non-conductive central plate 540, the two neighboring battery cells are electrically isolated from each other.

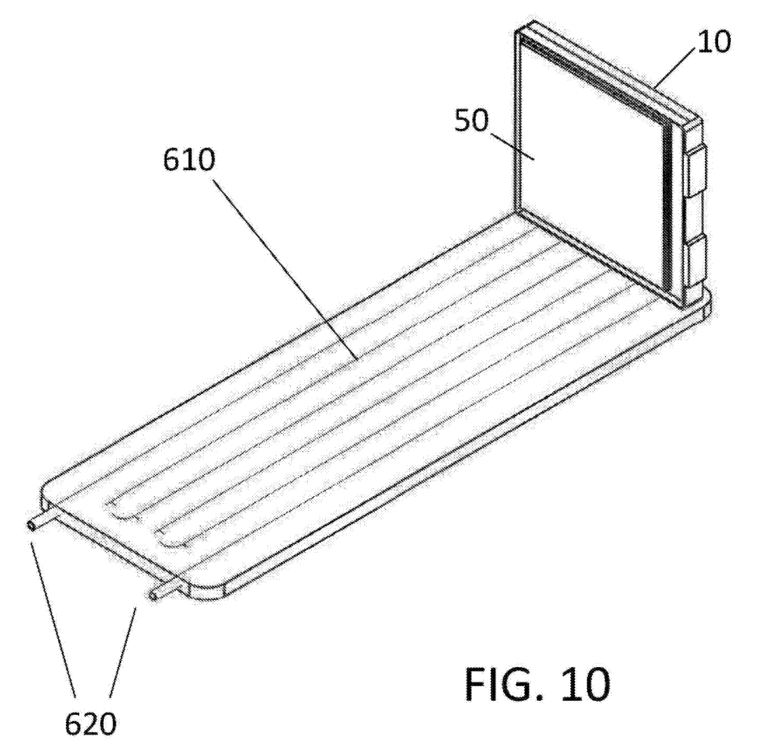

FIG. 10 illustrates the graphene enhanced cooling fin of FIG. 1 with a battery cell engaged thereto, with the enhanced cooling fin installed to an exemplary liquid cooled cooling plate. Graphene enhanced cooling fin 10 is illustrated with battery cell 50 engaged thereto. Cooling plate 610 is illustrated with liquid cooling lines 620 provided, where a liquid coolant can be forced through cooling lines 620 to remove heat from cooling plate 610. Cooling plate 610 can include graphene enhanced material. In some embodiments, cooling plate 610 may not need to be liquid cooled.

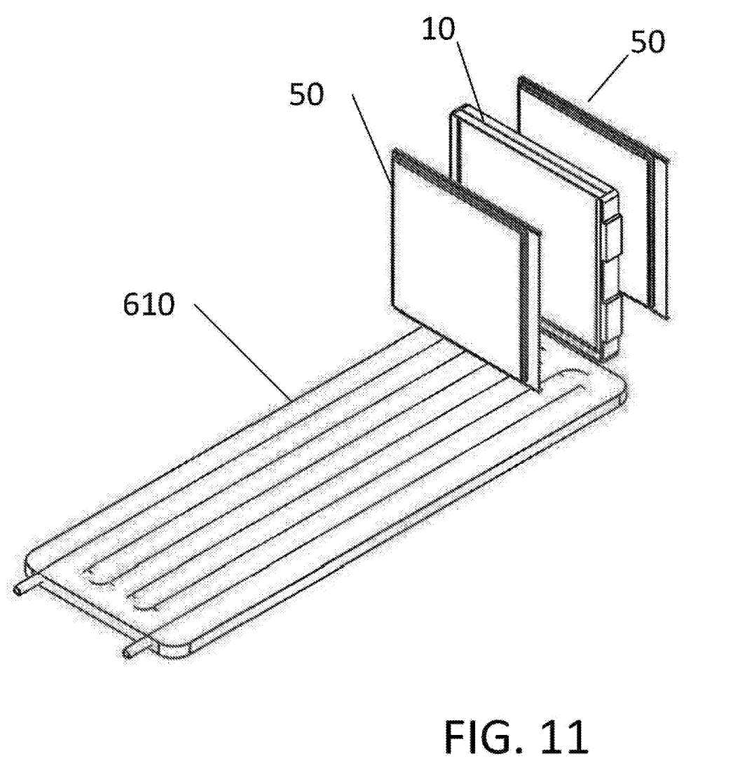

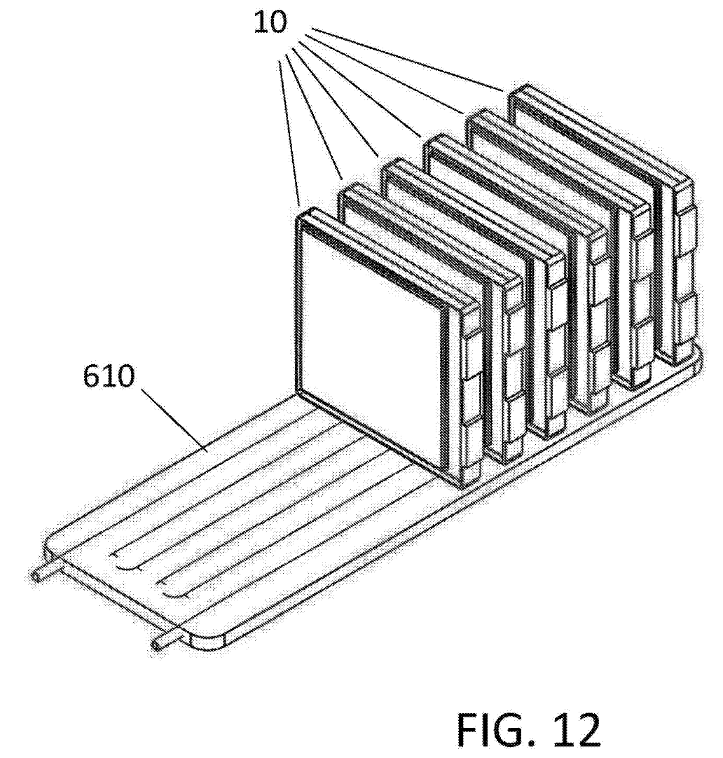

FIG. 11 illustrates the graphene enhanced cooling fin of FIG. 10 separated from the cooling plate for illustration, with two battery cells positioned to be engaged to either side of the enhanced cooling fin. Enhanced cooling fin 10 is illustrated, including two battery cells 50 illustrated in a position in preparation to be engaged to either side of enhanced cooling fin 10. Enhanced cooling fin 10 can be attached to cooling plate 610 as is illustrated in FIG. 10.

FIG. 12 illustrates a plurality of enhanced cooling fins attached to the cooling plate of FIG. 10. Cooling plate 610 is illustrated, and a plurality of graphene enhanced cooling fins 10 are attached to cooling plate 610. A battery cell can be located between each of the enhanced cooling fins 10.

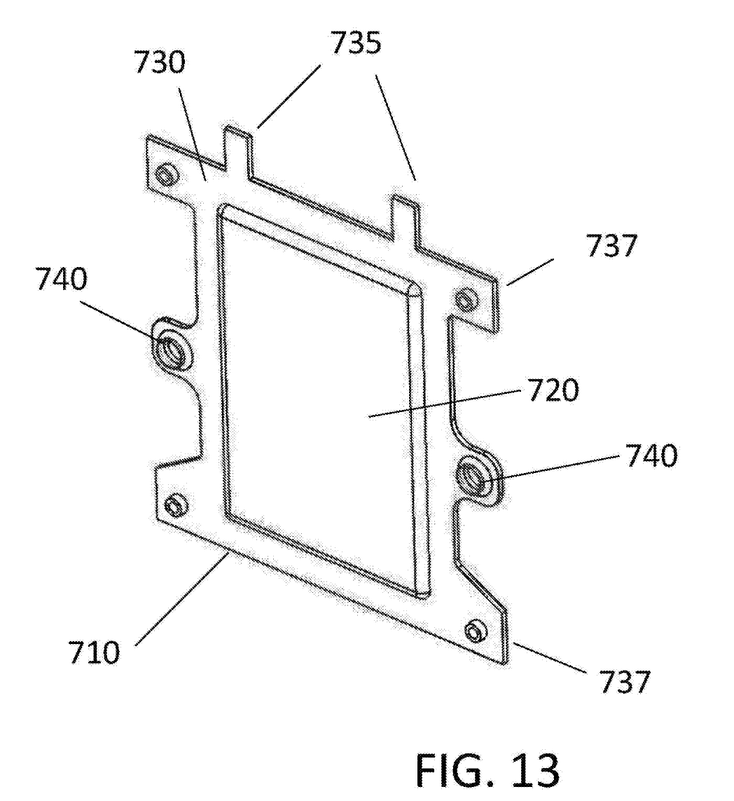

FIGS. 13-16 illustrate an additional embodiment of battery cell components that are made with plastic enhanced with graphene. FIG. 13 illustrates a plastic housing enhanced with graphene configured to transfer heat away from a battery core. Graphene enhanced cooling fin 710 is illustrated including flat panel portion 720 and structural rim portion 730. Flat panel portion 720 includes an optional indented pocket configured to securely locate a battery cell between the enhanced cooling fin and a second enhanced cooling fin. Structural rim portion 730 includes structural tabs 737 including holes configured to accept fasteners or pins to hold enhanced cooling fin 710 in place and structural tabs 735 for some other purpose such as securing the enhanced cooling fin 710 to some other structure or device. Structural rim portion 730 is similar to structural rim portion 30 of FIG. 1, except that surfaces of structural rim portion 730 are generally parallel to flat panel portion 720. Coolant line brackets 740 are provided, such that a liquid filled coolant line can be inserted within coolant line brackets 740 for the purpose of transmitting heat away from enhanced cooling fin 710. By enhancing enhanced cooling fin 710 to promote a rate of heat transfer from flat panel portion 720 to coolant line brackets 740, performance of enhanced cooling fin 710 can be improved.

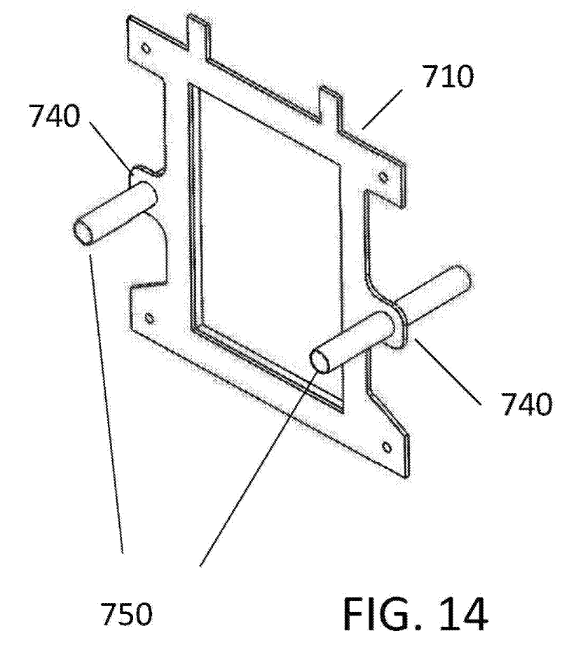

FIG. 14 illustrates coolant lines that can be installed to the enhanced cooling fin of FIG. 13 in order to transfer heat away from the enhanced cooling fin. Enhanced cooling fin 710 if FIG. 13 is illustrated, with coolant lines 750 installed to coolant line brackets 740.

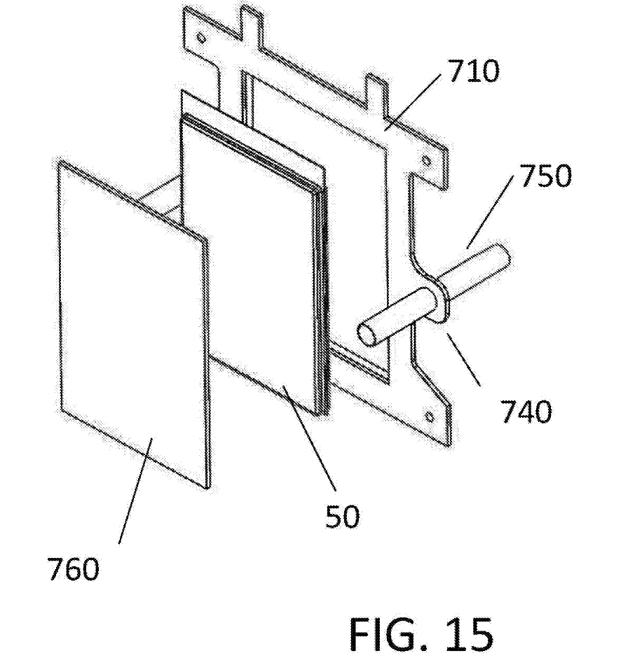

FIG. 15 illustrates the enhanced cooling fin and coolant lines of FIG. 14, with a battery core and a cover in an expanded view, with the core in position to be placed within an indented pocket in the enhanced cooling fin. Enhanced cooling fin 710 of FIG. 13 is illustrated, with coolant lines 750 installed to coolant line brackets 740. Battery cell 50 is illustrate positioned in preparation for being engaged to an indented pocket formed in the face of enhanced cooling fin 710. A plastic cover 760 is illustrated positioned in preparation for being applied over battery cell 50 once it is engaged to enhanced cooling fin 710. Plastic cover 760 may be enhanced with graphene and can seal or encapsulate battery cell 50 against enhanced cooling fin 710.

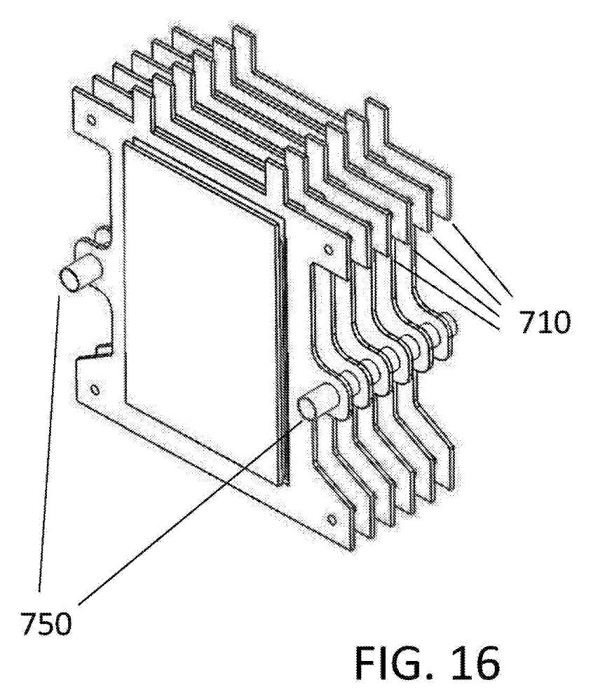

FIG. 16 illustrates a plurality of enhanced cooling fins with battery cores installed thereto stacked and attached to coolant lines. A plurality of enhanced cooling fins 710 are illustrated stacked against each other, with battery cells contained therebetween and/or therewithin, with coolant lines 750 attached to the enhanced cooling fins 710. As coolant is forced through coolant lines 750, heat is transferred away from enhanced cooling fins 710.

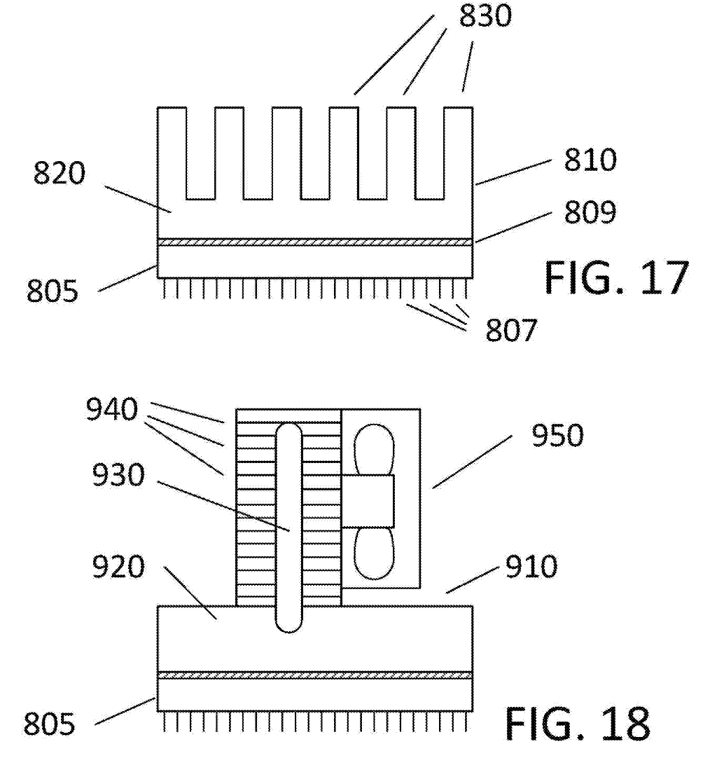

Other types of heat exchangers can benefit from graphene enhanced cooling fins and particularly graphene enhanced plastic cooling fins. FIG. 17 illustrates an exemplary central processing unit cooling fin constructed with a graphene enhanced plastic material. Central processing unit (CPU) chip 805 is illustrated including a plurality of pins 807 configured to connect chip 805 to a computer motherboard. It is known that such CPU chips generate a lot of heat during operation. Graphene enhanced plastic cooling fin 810 is illustrated, connected to CPU chip 805 with silver thermal paste layer 809. Enhanced plastic cooling fin 810 includes base portion 820 configured to span and receive heat from CPU chip 805. Enhanced plastic cooling fin 810 further includes air cooled fins 830 configured to expel heat to air proximate to the fins. Any portion or all of enhanced plastic cooling fin 810 can include graphene layers or graphene interspersed within the fin material to enhance heat transfer properties.

FIG. 18 illustrates an additional exemplary central processing unit cooling fin constructed with a graphene enhanced plastic material and including a phase change circuit. CPU chip 805 is illustrated. Cooling fin assembly 910 is illustrated including base portion 920 configured to span and receive heat from CPU chip 805, stacked air cooled heat transfer fins 940, phase change circuit 930 including a liquid configured to transfer heat from base portion 920 to heat transfer fins 940, and powered fan unit 950 blowing air through heat transfer fins 940. Any or all portions of cooling fin assembly 910 can include graphene layers or graphene interspersed within the fin material to enhance heat transfer properties.

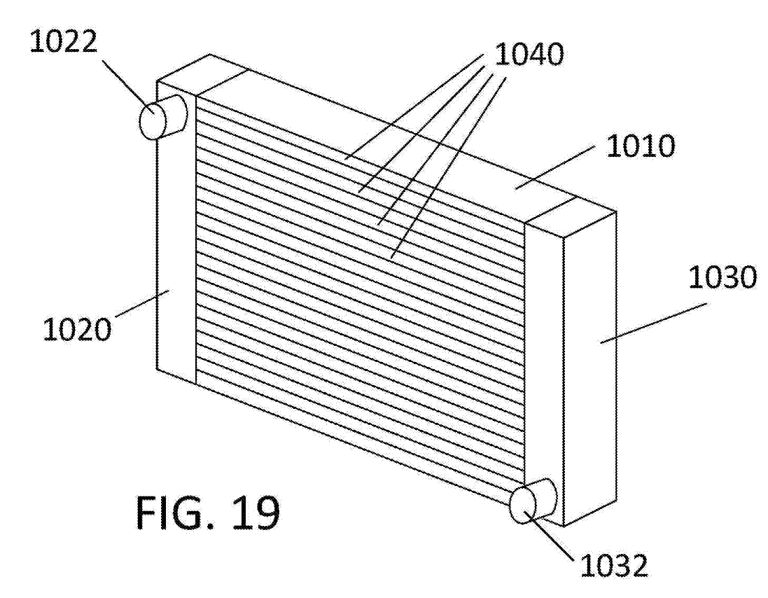

FIG. 19 illustrates an exemplary radiator device used in automotive applications with graphene enhanced plastic cooling structures. Radiator device 1010 is illustrated including a first header 1020, a second header 1030, and a plurality of flattened tubes 1040 connecting the two headers. Liquid is forced in one fluid tube 1022, passes through header 1020, through attached tubes 1040, into header 1030, and out a second fluid tube 1032. As is known in the art, headers can be configured to force the liquid to make multiple passes back and forth through the tubes in order to achieve maximum cooling. As is also known in the art, fins can be formed or sandwiched between tubes 1040 in order to maximize surface area and heat transfer between the liquid within the tubes and air passing through radiator device 1010. such a heat exchanger is typically constructed with aluminum tubes and fins and with plastic headers. Any of the surfaces of the radiator device can be enhanced with graphene to improve heat transfer characteristics. Further, as is achieved in the enhanced cooling fin of FIG. 1, the device of FIG. 19 can be simplified by, for example, only using one header, with a fluid tube at a top and a bottom, with graphene enhanced, air cooled tubes extending outwardly from the header. This would eliminate the weight and leakage failures caused by running tubes 1040 between two headers. In another embodiment, both headers 1020 and 1030 could each include two fluid tubes, each having a fluid flow just through the header, and with air-cooled graphene enhanced fins extending between the headers. FIG. 19 illustrates a fluid to air heat exchanger. Other fluid to air heat exchangers can be similarly improved, such as an air conditioning evaporator core or condenser core. Similarly, a fluid to fluid heat exchanger or an air to air heat exchanger can be similar improved, for example, replacing tubes carrying a flow through the tube with a simple fin attached to a header unit.

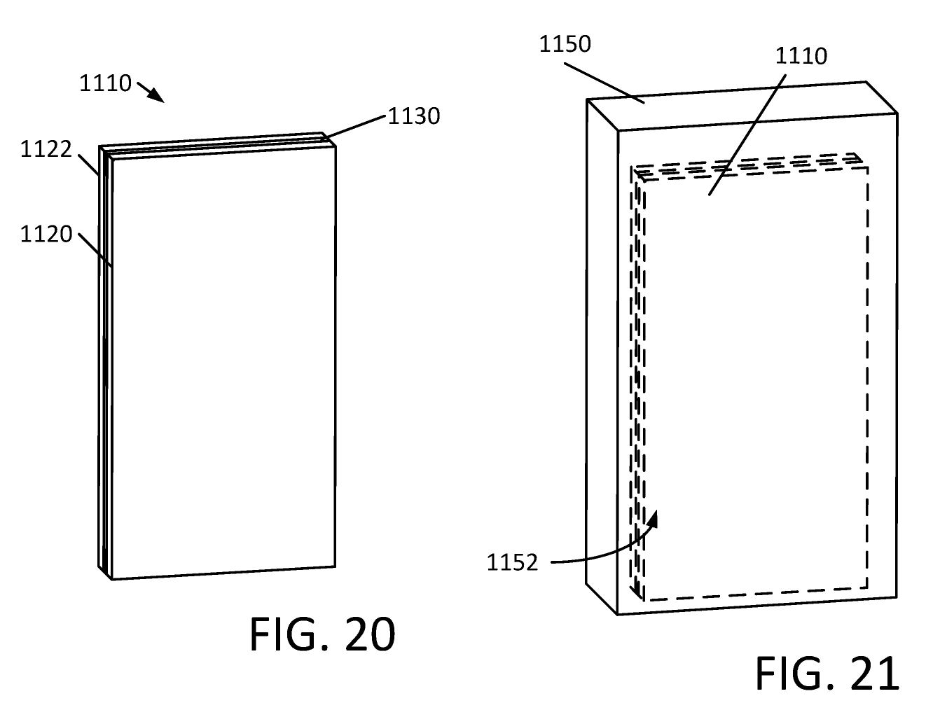

FIG. 20 illustrates an exemplary pair of aluminum plates with a layer of graphene materials interposed between the plates. Enhanced aluminum plate assembly 1110 is illustrated including a first aluminum plate 1120, a second aluminum plate 1122, and a layer of graphene materials 1130 interposed between the aluminum plates. Enhanced aluminum plate assembly 1110 is useful to efficiently distribute heat through and across the layer of graphene materials 1130.

FIG. 21 illustrates the aluminum plates and graphene materials of FIG. 20 encased within a molded plastic unit. Enhanced aluminum plate assembly 1110 of FIG. 20 is illustrated surrounded by plastic materials of molded plastic unit 1150. In one embodiment, in a process known in the art as insert molding, enhanced aluminum plate assembly 1110 can be placed within an injection mold cavity, and plastic material can be injection molded around assembly 1110 to form molded plastic unit 1150. Front surface 1152 of unit 1150 can be configured to receive heat, for example, as from a neighboring battery cell. An edge of enhanced aluminum plate assembly 1110 can be exposed from a side of unit 1150, for example, allowing heat to transferred from enhanced aluminum plate assembly 1110.

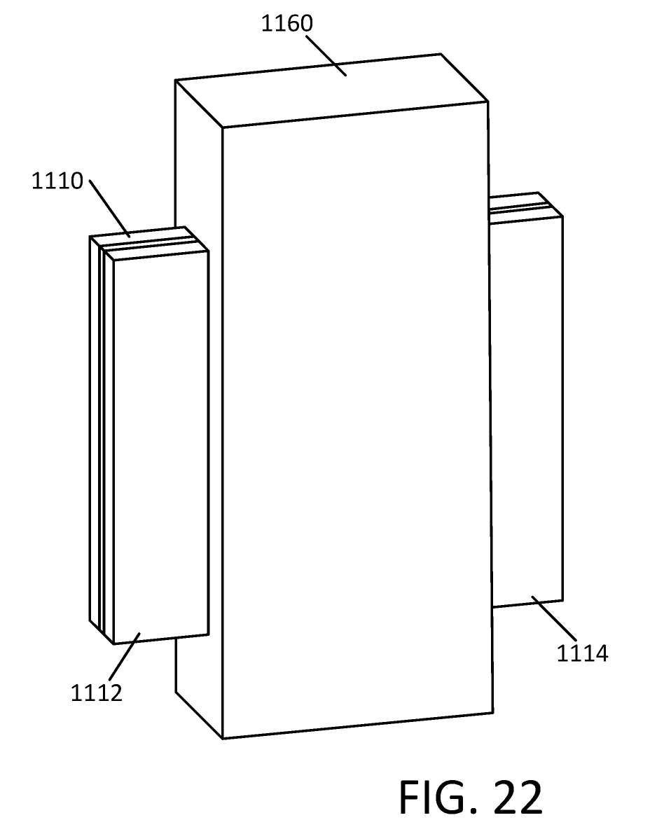

FIG. 22 illustrates the aluminum plates and graphene materials of FIG. 20 partially encased within a molded plastic unit, with heat rejection fins exposed on either side of the aluminum plates. Enhanced aluminum plate assembly 1110 of FIG. 20 is illustrated surrounded by plastic materials of molded plastic unit 1160. In one embodiment, in a process known in the art as insert molding, enhanced aluminum plate assembly 1110 can be placed within an injection mold cavity, and plastic material can be injection molded around assembly 1110 to form molded plastic unit 1160. A first portion 1112 and a second portion 1114 of enhanced aluminum plate assembly 1110 protrude from unit 1160, such that portions 1112 and 1114 are exposed. In one embodiment, portion 1112 and 1114 can act as heat fins, exchanging heat with nearby air or liquid flowing around portions 1112 and 1114. In one embodiment, heat transferred to portion 1112 can flow through enhanced aluminum plate assembly 1110 to portion 1114 and subsequently flow to a gas or liquid proximate to portion 1114.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. An apparatus for cooling a multi-battery cell energy storage device, the apparatus comprising:
a graphene enhanced cooling fin comprising:
a flat panel portion configured to abut one of the battery cells, the flat panel portion comprising a graphene enhanced portion configured to transmit heat away from the one of the battery cells; and
a plastic structural rim portion surrounding the flat panel portion.

2. The apparatus of claim 1, wherein the flat panel portion comprises an indented pocket configured to hold the one of the battery cells.

3. The apparatus of claim 1, wherein the flat panel portion comprises graphene enhanced plastic material.

4. The apparatus of claim 3, wherein the graphene enhanced plastic material comprises a layer of graphene platelets.

5. The apparatus of claim 3, wherein the graphene enhanced plastic material comprises a graphene platelets interspersed within plastic material.

6. The apparatus of claim 1, wherein the flat panel portion comprises a graphene enhanced aluminum fin; and
wherein the plastic structural rim portion comprises a graphene enhanced plastic material.

7. The apparatus of claim 6, wherein the flat panel portion further comprises a layer of plastic covering the aluminum fin.

8. The apparatus of claim 1, wherein the graphene enhanced cooling fin further comprises a non-conductive plastic core coated on at least one side with a graphene enhanced plastic material.

9. The apparatus of claim 1, wherein the plastic structural rim portion comprises a rim surface perpendicular to the flat panel portion.

10. The apparatus of claim 1, wherein the plastic structural rim portion comprises a rim surface parallel to the flat panel portion.

11. The apparatus of claim 1, wherein the plastic structural rim portion comprises at least one hole configured to receive a cooling tube.

12. The apparatus of claim 1, further comprising a plastic cover configured to hold a battery cell against the flat panel portion.

13. An apparatus for cooling a multi-battery cell energy storage device, the apparatus comprising:
a rectangle-shape graphene enhanced cooling fin comprising:
a flat panel portion configured to abut one of the battery cells, the flat panel portion comprising a graphene enhanced portion configured to transmit heat away from the one of the battery cells; and
a plastic structural rim portion surrounding the flat panel portion comprising four rim surfaces perpendicular to the flat panel portion, wherein at least one of the rim surfaces comprises a graphene enhanced plastic material.

14. An apparatus for cooling a multi-battery cell energy storage device, the apparatus comprising:
a graphene enhanced cooling fin comprising:
a flat panel portion configured to abut one of the battery cells, the flat panel portion comprising a graphene enhanced portion configured to transmit heat away from the one of the battery cells; and
a plastic structural rim portion surrounding the flat panel portion comprising rim surfaces parallel to the flat panel portion, wherein at least one of the rim surfaces comprises a hole configured to accept a cooling tube.
